(19) United States
(12) Patent Application Publication
(10) Pub. No.: US 2025/0121840 A1
(43) Pub. Date: Apr. 17, 2025

(54) APPARATUS FOR CONTROLLING A VEHICLE AND METHOD THEREOF

(71) Applicants: Hyundai Motor Company, Soul (KR); Kia Corporation, Seoul (KR)

(72) Inventor: Hyun Ju KIM, Yongin-Si (KR)

(21) Appl. No.: 18/769,018

(22) Filed: Jul. 10, 2024

(30) Foreign Application Priority Data
Oct. 13, 2023 (KR) 10-2023-0136880

(51) Int. Cl. B60W 50/08; B60W 60/00

(52) U.S. Cl. CPC B60W 50/085; B60W 60/0015; B60W 2420/408; B60W 2554/4041

(57) ABSTRACT

In a vehicle control apparatus and a method thereof, the vehicle control apparatus may include a light detection and ranging (LiDAR), a memory, and a processor including at least one core. The processor may receive, from the LiDAR, one of driving information associated with driving of an external vehicle, type information associated with a type of the external vehicle, or a first signal indicating an error occurring in the LiDAR, and may switch a mode associated with driving to an emergency mode different from a normal mode for outputting first information, which corresponds to the external vehicle and which is generated by use of first data associated with the driving of the external vehicle stored in the memory, second data associated with the type of the external vehicle stored in the memory, the driving information, and the type information, based on the driving information or the type information, which is incapable of occupying the at least one core, or receiving the first signal.

### CROSS-REFERENCE TO RELATED APPLICATION

The present application claims priority to Korean Patent Application No. 10-2023-0136880, filed on Oct. 13, 2023, the entire contents of which is incorporated herein for all purposes by this reference.

### BACKGROUND OF THE PRESENT DISCLOSURE

### Field of the Present Disclosure

The present disclosure relates to a vehicle control apparatus and a method thereof, and more particularly, relates to a technology for using light detection and ranging (LiDAR).

### Description of Related art

Autonomous vehicles or vehicles having activated driving assistance devices may identify surrounding environments through LiDAR and may collect data for driving.

A vehicle may obtain data indicating a location of an object around the vehicle through the LiDAR. The LiDAR may obtain a distance from the LiDAR to the object through an interval a point in time when a laser beam is transmitted and a point in time when the laser beam reflected from the object is received. The vehicle may identify a location at a point included in the outside of the object in space where the vehicle is located, based on an angle of the transmitted laser beam and the distance to the object.

The autonomous vehicles or vehicles having the activated driving assistance devices may identify information of the object represented by points based on movement information of the obtained points. A technology for determining whether an object is an object in a moving state, an object capable of being in a moving state, or an object incapable of being in a moving state may be essential to ensure the safety of autonomous driving or driving based on the driving assistance devices and to reduce the risk of an accident.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle control apparatus that prevents initialization of the vehicle control apparatus or a vehicle control system including the vehicle control apparatus even when an error occurs due to a Light Detection and Ranging (LiDAR), and a method thereof.

Various aspects of the present disclosure are directed to providing a vehicle control apparatus that performs an operation different depending on information indicating that a core included in a processor is occupied, and a method thereof.

Various aspects of the present disclosure are directed to providing a vehicle control apparatus that provides a function of stably assisting the driving of a vehicle including the vehicle control apparatus by not initializing the vehicle control apparatus or the vehicle control system including the vehicle control apparatus, even when an error occurring in LiDAR is identified, and a method thereof.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, a vehicle control apparatus may include a light detection and ranging (LiDAR), a memory, and a processor including at least one core. The processor may receive, from the LiDAR, one of driving information associated with driving of an external vehicle, type information associated with a type of the external vehicle, or a first signal indicating an error occurring in the LiDAR, and may switch a mode associated with driving to an emergency mode different from a normal mode for outputting first information, which corresponds to the external vehicle and which is generated by use of first data associated with the driving of the external vehicle stored in the memory, second data associated with the type of the external vehicle stored in the memory, the driving information, and the type information, based on the driving information or the type information, which is incapable of occupying the at least one core, or receiving the first signal.

In an exemplary embodiment of the present disclosure, the processor may not output the first information based on switching the mode associated with the driving to the emergency mode, may reduce reliability of the first information output at a first end time point after a first start time point of an output section, in which driving information is output, to be lower than reliability of the driving information output before the first start time point, and may output the first information having the reduced reliability.

In an exemplary embodiment of the present disclosure, the processor may switch the mode associated with the driving from the normal mode to the emergency mode based on receiving the first signal, may generate second information corresponding to the external vehicle by use of the first data and the second data, and may store the second information in the memory.

In an exemplary embodiment of the present disclosure, the processor may switch the mode associated with the driving from the normal mode to the emergency mode based on identifying that the type information is incapable of occupying the at least one core, as the driving information occupies the at least one core, and may output fourth information, which corresponds to the external vehicle and which is generated by use of the first data and the second data, based on a fact that occupation of the driving information is released, after a second end time point of an output section for outputting third information, which corresponds to the external vehicle and which is generated by use of the first data, the second data, and the driving information.

In an exemplary embodiment of the present disclosure, the processor may switch the mode associated with the driving from the normal mode to the emergency mode based on identifying that the type information is incapable of occupying the at least one core, as the driving information occupies the at least one core, and may not output third information based on a fact that occupation of the driving information is released, between a second start time point and a second end time point of an output section for outputting the third information, which corresponds to the external vehicle and which is generated by use of the first data, the second data, and the driving information.

In an exemplary embodiment of the present disclosure, the processor may switch the mode associated with the driving from the normal mode to the emergency mode based on identifying that the driving information is incapable of occupying the at least one core, as the type information occupies the at least one core, and may delete the first data, the second data, the driving information, and the type information from the memory based on occupation of the type information is released, after a third end time point of an output section for outputting fifth information, which corresponds to the external vehicle and which is generated by use of the first data, the second data, and the type information.

In an exemplary embodiment of the present disclosure, the processor may switch the mode associated with the driving from the normal mode to the emergency mode based on identifying that the driving information is incapable of occupying the at least one core, as the type information occupies the at least one core, and may not output fifth information based on a fact that occupation of the type information is released, between a third start time point and a third end time point of an output section for outputting the fifth information, which corresponds to the external vehicle and which is generated by use of the first data, the second data, and the driving information.

In an exemplary embodiment of the present disclosure, the processor may not output the first information based on a fact that an output of the first information starts, after a fourth start time point of an output section for outputting the first information, and may output sixth information, which corresponds to the external vehicle, which is generated by use of the first data, the second data, the driving information, and the type information, and which is obtained after the fourth start time point.

In an exemplary embodiment of the present disclosure, the processor may identify a priority of each of external objects based on at least one of a location of each of the external objects including the external vehicle, a size of each of virtual boxes respectively corresponding to the plurality of external objects, the number of points included in each of the virtual boxes, a type of each of the external objects, or a lane on which external vehicles included in the plurality of external objects are driving, or any combination thereof, and may output information different from the driving information in the emergency mode, based on the priority.

In an exemplary embodiment of the present disclosure, the processor may identify a first lane, on which a vehicle is driving, and a second lane on which the external vehicle is driving, may identify a priority of the external vehicle based on a distance between the first lane and the second lane, and may output information different from the driving information in the emergency mode, based on the priority.

According to an aspect of the present disclosure, a vehicle control method may include receiving, from a LiDAR, one of driving information associated with driving of an external vehicle, type information associated with a type of the external vehicle, or a first signal indicating an error occurring in the LiDAR, and switching a mode associated with driving to an emergency mode different from a normal mode for outputting first information, which corresponds to the external vehicle and which is generated by use of first data associated with the driving of the external vehicle stored in a memory, second data associated with the type of the external vehicle stored in the memory, the driving information, and the type information, based on the driving information or the type information, which is incapable of occupying the at least one core, or receiving the first signal.

According to an exemplary embodiment of the present disclosure, the vehicle control method may include not outputting the first information based on switching the mode associated with the driving to the emergency mode, reducing reliability of the first information output at a first end time point after a first start time point of an output section, in which driving information is output, to be lower than reliability of the driving information output before the first start time point, and outputting the first information having the reduced reliability.

According to an exemplary embodiment of the present disclosure, the vehicle control method may include switching the mode associated with the driving from the normal mode to the emergency mode based on receiving the first signal, generating second information corresponding to the external vehicle by use of the first data and the second data, and storing the second information in the memory.

According to an exemplary embodiment of the present disclosure, the vehicle control method may include switching the mode associated with the driving from the normal mode to the emergency mode based on identifying that the type information is incapable of occupying the at least one core, as the driving information occupies the at least one core, and outputting fourth information, which corresponds to the external vehicle and which is generated by use of the first data and the second data, based on a fact that occupation of the driving information is released, after a second end time point of an output section for outputting third information, which corresponds to the external vehicle and which is generated by use of the first data, the second data, and the driving information.

According to an exemplary embodiment of the present disclosure, the vehicle control method may include switching the mode associated with the driving from the normal mode to the emergency mode based on identifying that the type information is incapable of occupying the at least one core, as the driving information occupies the at least one core, and not outputting third information based on a fact that occupation of the driving information is released, between a second start time point and a second end time point of an output section for outputting the third information, which corresponds to the external vehicle and which is generated by use of the first data, the second data, and the driving information.

According to an exemplary embodiment of the present disclosure, the vehicle control method may include switching the mode associated with the driving from the normal mode to the emergency mode based on identifying that the driving information is incapable of occupying the at least one core, as the type information occupies the at least one core, and deleting the first data, the second data, the driving information, and the type information from the memory based on occupation of the type information is released, after a third end time point of an output section for outputting fifth information, which corresponds to the external vehicle and which is generated by use of the first data, the second data, and the type information.

According to an exemplary embodiment of the present disclosure, the vehicle control method may include switching the mode associated with the driving from the normal mode to the emergency mode based on identifying that the driving information is incapable of occupying the at least one core, as the type information occupies the at least one core, and not outputting fifth information based on a fact that occupation of the type information is released, between a third start time point and a third end time point of an output section for outputting the fifth information, which corresponds to the external vehicle and which is generated by use of the first data, the second data, and the driving information.

According to an exemplary embodiment of the present disclosure, the vehicle control method may include not outputting the first information based on a fact that an output of the first information starts, after a fourth start time point of an output section for outputting the first information, and outputting sixth information, which corresponds to the external vehicle, which is generated by use of the first data, the second data, the driving information, and the type information, and which is obtained after the fourth start time point.

According to an exemplary embodiment of the present disclosure, the vehicle control method may include identifying a priority of each of external objects based on at least one of a location of each of the external objects including the external vehicle, a size of each of virtual boxes respectively corresponding to the plurality of external objects, the number of points included in each of the virtual boxes, a type of each of the external objects, or a lane on which external vehicles included in the plurality of external objects are driving, or any combination thereof, and outputting information different from the driving information in the emergency mode, based on the priority.

According to an exemplary embodiment of the present disclosure, the vehicle control method may include identifying a first lane, on which a vehicle is driving, and a second lane on which the external vehicle is driving, identifying a priority of the external vehicle based on a distance between the first lane and the second lane, and outputting information different from the driving information in the emergency mode, based on the priority.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 shows an example of a block diagram of a vehicle control apparatus, according to an exemplary embodiment of the present disclosure;

FIG. 2 shows examples of a vehicle control apparatus that switches a mode associated with driving from a normal mode to an emergency mode, in an exemplary embodiment of the present disclosure;

FIG. 3 shows an example of a vehicle control apparatus that switches a mode associated with driving from a normal mode to an emergency mode, in an exemplary embodiment of the present disclosure;

FIG. 4 shows an example of a vehicle control apparatus that switches a mode associated with driving from a normal mode to an emergency mode, in an exemplary embodiment of the present disclosure;

FIG. 5 shows an example of a vehicle control apparatus that switches a mode associated with driving from a normal mode to an emergency mode, in an exemplary embodiment of the present disclosure;

FIG. 6 shows an example of a vehicle control apparatus that switches a mode associated with driving from a normal mode to an emergency mode, in an exemplary embodiment of the present disclosure;

FIG. 7 shows an example of a flowchart associated with a vehicle control method, according to an exemplary embodiment of the present disclosure;

FIG. 8 shows an example of a flowchart associated with a vehicle control method, according to an exemplary embodiment of the present disclosure; and

FIG. 9 illustrates a computing system associated with a vehicle control apparatus or vehicle control method, according to an exemplary embodiment of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the accompanying drawings. In adding reference numerals to components of each drawing, it should be noted that the same components include the same reference numerals, although they are indicated on another drawing. Furthermore, in describing the exemplary embodiments of the present disclosure, detailed descriptions associated with well-known functions or configurations will be omitted when they may make subject matters of the present disclosure unnecessarily obscure.

In describing elements of an exemplary embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It will be understood that terms used herein should be interpreted as having a meaning which is consistent with their meaning in the context of the present disclosure and the relevant art and will not be interpreted in an idealized or overly formal sense unless expressly so defined herein.

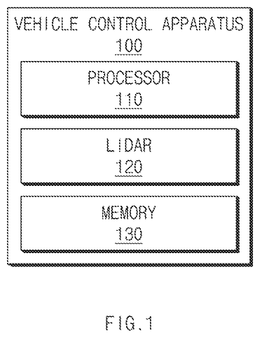

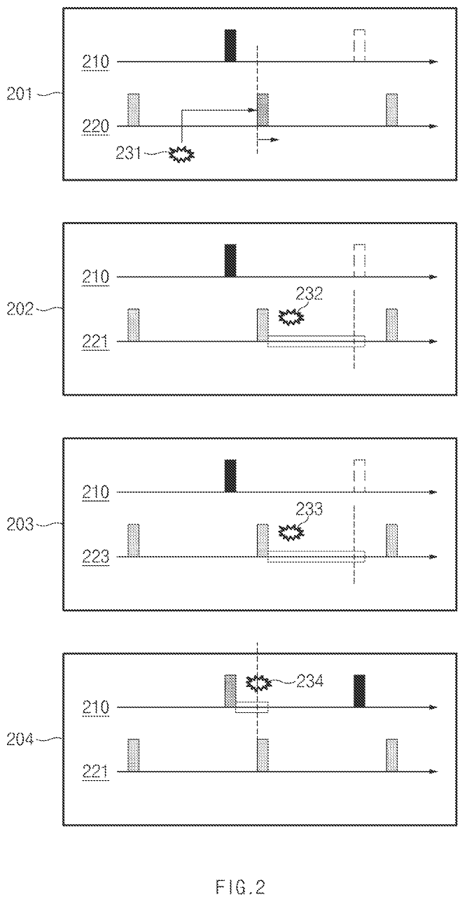

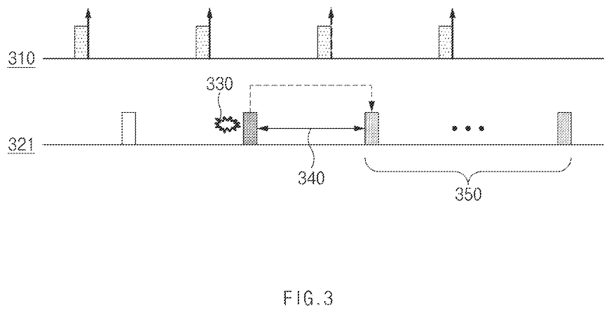

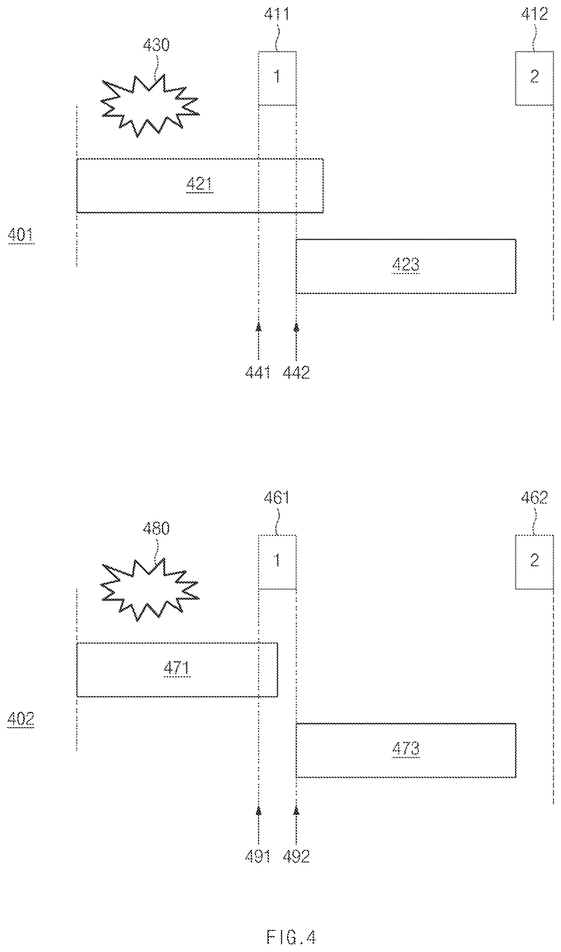

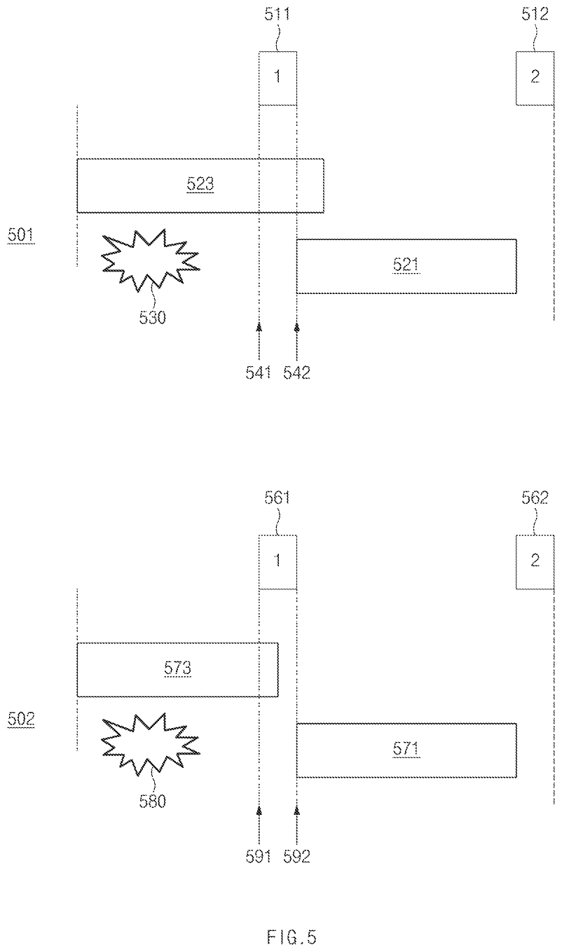

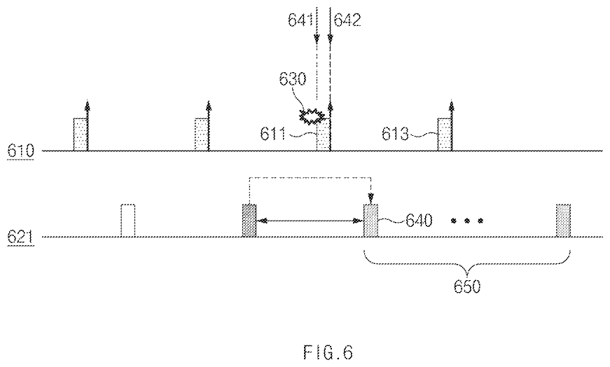

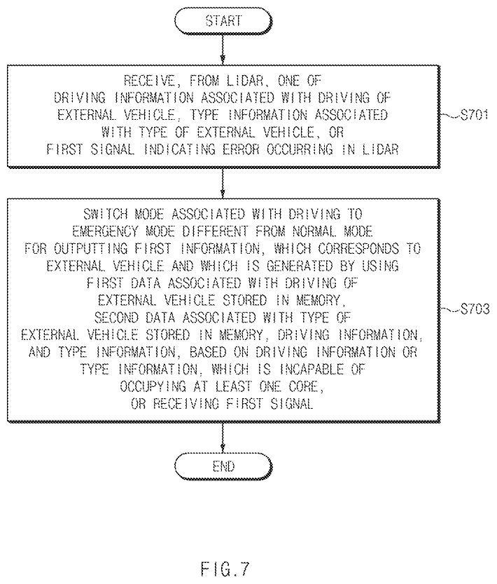

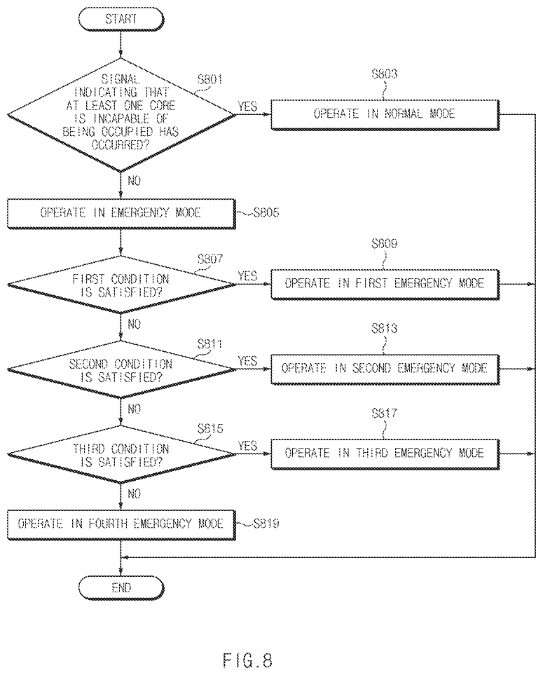

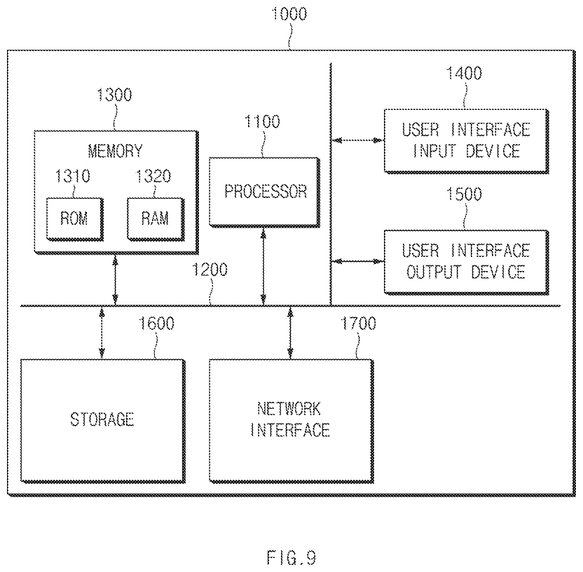

Hereinafter, various embodiments of the present disclosure will be described in detail with reference to FIG. 1, FIG. 2, FIG. 3, FIG. 4, FIG. 5, FIG. 6, FIG. 7, FIG. 8 and FIG. 9.

FIG. 1 shows an example of a block diagram of a vehicle control apparatus, according to an exemplary embodiment of the present disclosure.

Referring to FIG. 1, a vehicle control apparatus 100 according to an exemplary embodiment of the present disclosure may be implemented inside or outside a vehicle, and some of components included in the vehicle control apparatus 100 may be implemented inside or outside the vehicle. At the instant time, the vehicle control apparatus 100 may be integrated with internal control units of a vehicle and may be implemented with a separate device to be connected to control units of the vehicle by a separate connection means. For example, the vehicle control apparatus 100 may further include components not shown in FIG. 1.

Referring to FIG. 1, the vehicle control apparatus 100 according to various exemplary embodiments of the present disclosure may include a processor 110, a LiDAR 120, and a memory 130. The processor 110, the LiDAR 120, or the memory 130 may be electrically and/or operably coupled with each other by an electronic component including a communication bus.

Hereinafter, the fact that pieces of hardware are coupled operably may include the fact that a direct and/or indirect connection between the pieces of hardware is established by wired and/or wirelessly so that second hardware is controlled by first hardware among the pieces of hardware.

Although different blocks are shown, an exemplary embodiment of the present disclosure is not limited thereto. Some of the pieces of hardware in FIG. 1 may be included in a single integrated circuit including a system on a chip (SoC). The type and/or number of hardware included in the vehicle control apparatus 100 is not limited to that shown in FIG. 1. For example, the vehicle control apparatus 100 may include only some of the pieces of hardware shown in FIG. 1.

The vehicle control apparatus 100 according to various exemplary embodiments of the present disclosure may include hardware for processing data based on one or more instructions. For example, the hardware for processing data may include the processor 110. For example, the processor 110 may include at least one core.

For example, the hardware for processing data may include an arithmetic and logic unit (ALU), a floating point unit (FPU), a field programmable gate array (FPGA), a central processing unit (CPU), and/or an application processor (AP). The processor 110 may include a structure of a single-core processor, or may include a structure of a multi-core processor including a dual core, a quad core, a hexa core, or an octa core.

The LiDAR 120 included in the vehicle control apparatus 100 according to various exemplary embodiments of the present disclosure may obtain data sets from identifying objects surrounding the vehicle control apparatus 100. For example, the LiDAR 120 may identify at least one of a location of the surrounding object, a movement direction of the surrounding object, or a speed of the surrounding object, or any combination thereof based on a pulse laser signal emitted from the LiDAR 120 being reflected by the surrounding object and returned.

For example, the LiDAR 120 may obtain data sets including a plurality of points in the space defined by a first axis, a second axis, and a third axis based on a pulse laser signal reflected from surrounding objects. For example, the LiDAR 120 may obtain a data set including a plurality of points in the space, which is formed by the first axis, the second axis, and the third axis, based on receiving the pulse laser signal at a specified period.

For example, the first axis may include an x-axis. For example, the second axis may include a y-axis. For example, the third axis may include a z-axis. However, the first axis, the second axis, and/or the third axis is not limited to the above examples.

The memory 130 included in the vehicle control apparatus 100 according to various exemplary embodiments of the present disclosure may include a hardware component for storing data and/or instructions that are to be input and/or output to the processor 110 of the vehicle control apparatus 100.

For example, the memory 130 may include a volatile memory including a random-access memory (RAM), or a non-volatile memory including a read-only memory (ROM). For example, the volatile memory may include at least one of a dynamic RAM (DRAM), a static RAM (SRAM), a cache RAM, or a pseudo SRAM (PSRAM), or any combination thereof.

For example, the non-volatile memory includes at least one of a programmable ROM (PROM), an erasable PROM (EPROM), an electrically erasable PROM (EEPROM), a flash memory, a hard disk, a compact disk, a solid state drive (SSD), or an embedded multi-media card (eMMC), or any combination thereof.

In an exemplary embodiment of the present disclosure, the processor 110 may call specified information (or data) at a specified timing based on a scheduler. The processor 110 may cause at least one core included in the processor 110 to occupy the called information based on calling the specified information at the specified timing.

The processor 110 of the vehicle control apparatus 100 according to various exemplary embodiments of the present disclosure may obtain driving information associated with the driving of an external vehicle through the LiDAR 120. For example, the driving information associated with the driving of an external vehicle may include at least one of a speed of the external vehicle, a driving direction of the external vehicle, or a location of the external vehicle, or any combination thereof.

In an exemplary embodiment of the present disclosure, the processor 110 may obtain type information associated with the type of an external vehicle through the LiDAR 120. For example, the type of the external vehicle may include at least one of a sedan, a large truck, a 1-ton cargo truck, an SUV, a van, a 1-ton box truck, a trailer, or a large cargo truck, or any combination thereof.

In an exemplary embodiment of the present disclosure, the processor 110 may receive, from the LiDAR 120, one of driving information associated with the driving of the external vehicle, type information associated with the type of the external vehicle, or a first signal indicating an error occurring in the LiDAR 120. For example, the first signal indicating an error occurring in the LiDAR 120 may include a worst case execution time (WCET) signal.

In an exemplary embodiment of the present disclosure, the processor 110 may switch a mode associated with the driving to an emergency mode different from a normal mode for outputting first information corresponding to an external vehicle by use of first data associated with the driving of the external vehicle stored in the memory 130, second data associated with the type of the external vehicle stored in the memory 130, driving information, and type information based on the driving information or the type information being incapable of occupying at least one core of the processor 110, or receiving the first signal indicating an error occurring in the LiDAR 120.

For example, the first information corresponding to the external vehicle may include information for tracking the external vehicle. For example, the first information corresponding to the external vehicle may include information for expressing the external vehicle. For example, in a vehicle control system including the vehicle control apparatus 100, the processor 110 may assist the driving of the vehicle or may cause the vehicle to drive autonomously by outputting first information corresponding to the external vehicle.

Hereinafter, n-th information corresponding to the external vehicle may include information that causes operations performed by the first information described above.

When the mode associated with the driving is not switched to the emergency mode, the processor 110 may initialize a vehicle control apparatus 100 or a vehicle control system including the vehicle control apparatus 100.

For example, the first data may be generated based on tracking the external vehicle. For example, the first data may be generated based on at least one of a speed of the external vehicle, a driving direction of the external vehicle, or a location of the external vehicle, or any combination thereof in each of frames while the external vehicle is tracked.

For example, the second data may be generated based on tracking the external vehicle. For example, the second data may include the type of the external vehicle identified in each of the frames while the external vehicle is tracked.

In an exemplary embodiment of the present disclosure, the processor 110 may switch the mode associated with the driving from the normal mode to the emergency mode based on the driving information or the type information being incapable of occupying at least one core of the processor 110, or receiving the first signal.

In an exemplary embodiment of the present disclosure, the processor 110 may identify the priority of each of a plurality of external objects based on at least one of a location of each of the plurality of external objects including an external vehicle, a size of each of virtual boxes respectively corresponding to the plurality of external objects, the number of points included in each of virtual boxes, a type of each of the plurality of external objects, or a lane on which external vehicles included in the plurality of external objects are driving, or any combination thereof.

For example, the type of each of the plurality of external objects may include at least one of a pedestrian type, a pole indicating a boundary of a lane including a traffic pole, or a vehicle type, or any combination thereof.

The processor 110 may output information different from first information in the emergency mode based on identifying the priority of each of the plurality of external objects.

In an exemplary embodiment of the present disclosure, the processor 110 may identify a first lane on which the vehicle is driving, and a second lane on which the external vehicle is driving. The processor 110 may identify the priority of the external vehicle based on a distance between the first lane and the second lane. The processor 110 may output information different from first information in the emergency mode, based on the priority of the external vehicle.

For example, the processor 110 may identify that the external vehicle includes a first priority, based on the fact that the first lane and the second lane are the same as each other.

For example, the processor 110 may identify that the external vehicle is driving on a lane adjacent to the first lane on which the vehicle is driving, based on the fact that the distance between the first lane and the second lane is a first distance. The processor 110 may identify that the external vehicle has a second priority based on the fact that the external vehicle is driving on a lane adjacent to the first lane on which the vehicle is driving.

For example, the processor 110 may identify that the external vehicle is driving on a lane spaced by a first specified distance (e.g., a distance corresponding to one lane) from the first lane, on which the vehicle is driving, based on the fact that a distance between the first lane and the second lane is a second distance exceeding the first distance. The processor 110 may identify that the external vehicle has a third priority, based on identifying that the external vehicle is driving on a lane spaced by the first specified distance from the first lane on which the vehicle is driving.

For example, the processor 110 may identify that the external vehicle is driving on a lane spaced by a second specified distance (e.g., a distance corresponding to two lanes) from the first lane, on which the vehicle is driving, based on the fact that a distance between the first lane and the second lane is a third distance exceeding the second distance. The processor 110 may identify that the external vehicle has a fourth priority, based on identifying that the external vehicle is driving on a lane spaced by the second specified distance from the first lane on which the vehicle is driving.

For example, the processor 110 may identify that the external vehicle, which is not identified as having the first to fourth priorities described above, has a fifth priority.

For example, the first priority may include a priority higher than the second priority. For example, the second priority may include a priority lower than the first priority and higher than the third priority. For example, the third priority may include a priority lower than the second priority and higher than the fourth priority. For example, the fourth priority may include a priority lower than the third priority and higher than the fifth priority.

In an exemplary embodiment of the present disclosure, the processor 110 may not output first information based on switching the mode associated with the driving from the normal mode to the emergency mode. For example, in the emergency mode, the processor 110 may not output the first information generated by use of first data associated with the driving of the external vehicle stored in the memory 130, second data associated with the type of the external vehicle stored in the memory 130, driving information associated with the driving of the external vehicle, and type information associated with the type of the external vehicle.

The processor 110 may identify an output section in which first information is output. The processor 110 may identify at least one of a first start time point, or a first end time point, or any combination thereof of the output section in which the first information is output. The processor 110 may reduce the reliability of the first information output at the first end time point after the first start time point of the first output section, in which the first information is output, to be lower than the reliability of first information output before the first start time point. The processor 110 may output the first information with reduced reliability.

In an exemplary embodiment of the present disclosure, the processor 110 may receive a first signal indicating an error occurring in the LiDAR 120. In an exemplary embodiment of the present disclosure, the processor 110 may switch the mode associated with the driving from the normal mode to the emergency mode based on receiving the first signal.

In an exemplary embodiment of the present disclosure, in the emergency mode, the processor 110 may be configured to generate second information corresponding to the external vehicle by use of the first data and the second data. For example, the processor 110 may be configured to generate second information corresponding to the external vehicle based on the first data associated with the driving of the external vehicle stored in the memory 130, and the second data associated with the type of external vehicle stored in the memory 130. The processor 110 may store second information generated by use of the first data and the second information in the memory 130.

In an exemplary embodiment of the present disclosure, the processor 110 may identify that type information is incapable of occupying at least one core as the driving information occupies the at least one core. The processor 110 may switch the mode associated with the driving from the normal mode to the emergency mode based on identifying that the type information is incapable of occupying at least one core as the driving information occupies the at least one core.

The processor 110 may be configured to generate third information corresponding to the external vehicle by use of the first data, the second data, and the driving information. For example, the processor 110 may identify that the occupation of the driving information is released, after a second end time point of an output section for outputting third information, which corresponds to the external vehicle and which is generated by use of the first data associated with the driving of the external vehicle stored in the memory 130, the second data associated with the type of external vehicle stored in the memory 130, and the driving information.

The processor 110 may output fourth information, which corresponds to the external vehicle and which is generated by use of the first data and the second data, based on the fact that the occupation of the driving information is released, after the second end time point of the output section for outputting the third information, which corresponds to the external vehicle and which is generated by use of the first data, the second data, and the driving information.

In an exemplary embodiment of the present disclosure, the processor 110 may identify that type information is incapable of occupying at least one core as the driving information occupies the at least one core. The processor 110 may switch the mode associated with the driving from the normal mode to the emergency mode based on the fact that the type information is incapable of occupying at least one core as the driving information occupies the at least one core.

The processor 110 may identify that the occupation of the driving information is released, between a second start time point and the second end time point of the output section for outputting the third information generated by use of the first data, the second data, and the driving information. The processor 110 may not output the third information between the second start time point and the second end time point based on the fact that the occupation of the driving information is released.

In an exemplary embodiment of the present disclosure, the processor 110 may identify that driving information is incapable of occupying at least one core, as the type information occupies the at least one core. The processor 110 may switch the mode associated with the driving from the normal mode to the emergency mode based on identifying that the driving information is incapable of occupying at least one core, as the type information occupies the at least one core.

For example, the processor 110 may identify that the occupation of the type information is released, after a third end time point of an output section for outputting fifth information, which corresponds to the external vehicle and which is generated by use of the first data associated with the driving of the external vehicle stored in the memory 130, the second data associated with the type of external vehicle stored in the memory 130, and the type information.

For example, the processor 110 may delete the first data associated with the driving of the external vehicle stored in the memory 130, the second data associated with the type of external vehicle stored in the memory 130, the type information, the driving information temporarily stored in the processor 110 or the memory 130, and the type information temporarily stored in the processor 110 or the memory 130 based on the fact that the occupation of the type information is released, after the third end time point of the output section for outputting the fifth information, which corresponds to the external vehicle and which is generated by use of the first data associated with the driving of the external vehicle stored in the memory 130, the second data associated with the type of external vehicle stored in the memory 130, and the type information.

For example, the processor 110 may delete, from the memory 130, the first data associated with the driving of the external vehicle stored in the memory 130, the second data associated with the type of external vehicle stored in the memory 130, the driving information, and the type information.

In an exemplary embodiment of the present disclosure, the processor 110 may identify that driving information is incapable of occupying at least one core, as the type information occupies the at least one core. The processor 110 may switch the mode associated with the driving from the normal mode to the emergency mode based on identifying that the driving information is incapable of occupying at least one core, as the type information occupies the at least one core.

For example, the processor 110 may identify that the occupation of the type information is released, between the third start time point and the third end time point of an output section for outputting fourth information, which corresponds to the external vehicle and which is generated by use of the first data associated with the driving of the external vehicle stored in the memory 130, the second data associated with the type of external vehicle stored in the memory 130, and the driving information. The processor 110 may not output the fourth information based on the fact that the occupation of type information is released, between the third start time point and the third end time point of the output section for outputting the fourth information, which corresponds to the external vehicle and which is generated by use of the first data, the second data, and the driving information.

In an exemplary embodiment of the present disclosure, the processor 110 may not output the first information based on the fact that the output of the first information starts after a fourth start time point of the output section for outputting the first information.

The processor 110 may output sixth information, which corresponds to the external vehicle, which is generated by use of the first data, the second data, the driving information, and the type information, and which is obtained after the fourth start time point.

As described above, the vehicle control apparatus 100 according to various exemplary embodiments of the present disclosure may switch the mode associated with the driving to the emergency mode based on identifying an error. The vehicle control apparatus 100 may not initialize the vehicle control apparatus 100, and/or the vehicle control system including the vehicle control apparatus 100 even when the vehicle control apparatus 100 identifies an error occurring in the LiDAR 120, providing a function of stably assisting the driving of a vehicle including the vehicle control apparatus 100.

FIG. 2 shows examples of a vehicle control apparatus that switches a mode associated with driving from a normal mode to an emergency mode, in an exemplary embodiment of the present disclosure.

Referring to FIG. 2, a processor (e.g., the processor 110 of FIG. 1) of a vehicle control apparatus (e.g., the vehicle control apparatus 100 of FIG. 1) according to various exemplary embodiments of the present disclosure may output information 210 corresponding to an external vehicle based on at least one of driving information associated with the driving of the external vehicle, type information associated with the type of the external vehicle, first data associated with the driving of the external vehicle stored in a memory (e.g., the memory 130 in FIG. 1), or second data associated with the type of the external vehicle stored in the memory, or any combination thereof.

Referring to a first example 201 in FIG. 2, the processor of the vehicle control apparatus according to various exemplary embodiments of the present disclosure may identify a signal 231 indicating an error in LiDAR (e.g., the LiDAR 120 in FIG. 1). For example, the processor may temporarily stop outputting information for expressing the external vehicle after receiving the signal 231, based on identifying the signal 231 indicating an error in the LiDAR. For example, the signal 231 indicating an error in the LiDAR may be transmitted from the LiDAR.

Referring to a second example 202 in FIG. 2, the processor of the vehicle control apparatus according to various exemplary embodiments of the present disclosure may receive driving information 221 associated with the driving of the external vehicle from the LiDAR. For example, the processor may receive the driving information 221 associated with the driving of the external vehicle based on a specified period and may output the information 210 corresponding to the external vehicle based on the received driving information 221.

In an exemplary embodiment of the present disclosure, while outputting the driving information 221 associated with the driving of the external vehicle, the processor may identify an error 232. For example, while the driving information 221 occupies at least one core included in the processor, the processor may identify the error 232. For example, the processor may identify that the type information is incapable of occupying at least one core, as the driving information 221 occupies the at least one core. The processor may identify the error 232 based on identifying that the type information is incapable occupying the at least one core as the driving information 221 occupies the at least one core.

In an exemplary embodiment of the present disclosure, the processor may switch a mode associated with driving from a normal mode to an emergency mode based on identifying the error 232 based on identifying that the type information is incapable of occupying at least one core, as the driving information 221 occupies the at least one core.

Referring to a third example 203 in FIG. 2, the processor of the vehicle control apparatus according to various exemplary embodiments of the present disclosure may receive type information 223 associated with the type of the external vehicle from the LiDAR. For example, the processor may receive the type information 223 associated with the type of the external vehicle based on a specified period and may output the information 210 corresponding to the external vehicle based on the received type information 223.

In an exemplary embodiment of the present disclosure, while outputting the type information 223 associated with the type of the external vehicle, the processor may identify an error 233. For example, while the type information 223 occupies at least one core included in the processor, the processor may identify the error 233. For example, the processor may identify that the driving information is incapable of occupying at least one core, as the type information 223 occupies the at least one core. The processor may identify the error 233 based on identifying that the driving information is incapable occupying the at least one core, as the type information 223 occupies the at least one core.

Referring to a fourth example 204 in FIG. 2, the processor of the vehicle control apparatus according to various exemplary embodiments of the present disclosure may identify an error 234 while outputting the information 210 corresponding to the external vehicle. For example, after the start time point of the output section for outputting the information 210 corresponding to the external vehicle, the processor may identify the error 234 based on the fact that the output of the information 210 corresponding to the external vehicle starts.

As described above, the vehicle control apparatus according to an exemplary embodiment is configured to perform an operation in an emergency mode, preventing a system including the vehicle control apparatus from being initialized. The vehicle control apparatus may provide a function of stably performing driving assistance of the vehicle or autonomous driving of the vehicle by preventing the system from being initialized.

FIG. 3 shows an example of a vehicle control apparatus that switches a mode associated with driving from a normal mode to an emergency mode, in an exemplary embodiment of the present disclosure.

Referring to FIG. 3, a processor (e.g., the processor 110 in FIG. 1) of a vehicle control apparatus (e.g., the vehicle control apparatus 100 of FIG. 1) according to various exemplary embodiments of the present disclosure may receive driving information 321 associated with the driving of an external vehicle from a LiDAR (e.g., the LiDAR 120 in FIG. 1).

In an exemplary embodiment of the present disclosure, the processor may receive the driving information 321 at a specified period 340. For example, the specified period 340 may include approximately 80 ms. However, the specified period 340 is not limited to the above examples.

In an exemplary embodiment of the present disclosure, the processor may identify an error 330 before the driving information 321 occupies at least one core included in the processor. The processor may temporarily stop outputting information 310, which corresponds to the external vehicle and which is generated by use of first data associated with the driving of the external vehicle stored in a memory (e.g., the memory 130 in FIG. 1), second data associated with the type of the external vehicle stored in the memory, and the driving information 321 based on identifying the error 330 before the driving information 321 occupies at least one core. The processor may not output the information 310, which corresponds to the external vehicle and which is generated by use of the first data, the second data, and the driving information 321 based on identifying the error 330 before the driving information 321 occupies at least one core.

For example, the information 310 corresponding to the external vehicle may include output information.

In an exemplary embodiment of the present disclosure, the processor may not output the information 310 corresponding to the external vehicle immediately after identifying the error 330. The processor may reduce the reliability of the driving information 310 received after the processor does not outputs the information 310 corresponding to the external vehicle. For example, the processor may reduce the reliability of the driving information 321, which is received after the processor does not output the information 310 corresponding to the external vehicle, to be lower than the reliability of information 321 received before the processor outputs the information 310 corresponding to the external vehicle.

In an exemplary embodiment of the present disclosure, the processor may reduce the reliability of the driving information 321 received after the processor does not outputs the information 310 corresponding to the external vehicle, for a specified duration 350. For example, while the driving information 321 is received the specified number of times, the processor may reduce the reliability of the driving information 321.

In an exemplary embodiment of the present disclosure, the processor is configured to output the information 310, which corresponds to the external vehicle and which is generated by use of the driving information 321 including the reduced reliability, the first data associated with the driving of the external vehicle stored in the memory, and the second data associated with the type of the external vehicle stored in the memory.

As described above, the vehicle control apparatus according to an exemplary embodiment is configured to perform an operation in an emergency mode, preventing a system including the vehicle control apparatus from being initialized. The vehicle control apparatus may provide a function of stably performing driving assistance of the vehicle or autonomous driving of the vehicle by preventing the system from being initialized.

FIG. 4 shows an example of a vehicle control apparatus that switches a mode associated with driving from a normal mode to an emergency mode, in an exemplary embodiment of the present disclosure.

Referring to FIG. 4, a processor (e.g., the processor 110 in FIG. 1) of a vehicle control apparatus (e.g., the vehicle control apparatus 100 of FIG. 1) according to various exemplary embodiments of the present disclosure may receive, from a LiDAR (e.g., the LiDAR 120 in FIG. 1), driving information 421 associated with driving of an external vehicle and type information 423 associated with the type of the external vehicle.

Referring to a first example 401 in FIG. 4, in an exemplary embodiment of the present disclosure, the processor may identify an error 430 caused by the driving information 421 associated with the driving of the external vehicle. For example, the processor may identify the error 430 caused by the driving information 421 occupying at least one core included in the processor. For example, the processor may identify that the type information 423 is incapable of occupying at least one core, as the driving information 421 occupies the at least one core included in the processor.

For example, the processor may identify the error 430 based on identifying that the type information 423 is incapable of occupying the at least one core, as the driving information 421 occupies the at least one core included in the processor.

For example, the processor may identify a start time point 441 of an output section where information 411 corresponding to the external vehicle is output, and an end time point 442 of the output section where the information 411 corresponding to the external vehicle is output.

In an exemplary embodiment of the present disclosure, the processor may identify that the occupation of the driving information 421 is released, after the end time point 442 of the output section where the information 411 corresponding to the external vehicle is output. The processor may identify that the type information 423 is incapable of occupying at least one core, based on identifying that the occupation of the driving information 421 is released, after the end time point 442.

The processor is configured to output the information 411 corresponding to the external vehicle by use of the driving information 421, first data associated with the driving of the external vehicle stored in a memory (e.g., the memory 130 in FIG. 1), and second data associated with the driving of the external vehicle stored in the memory based on the occupation of the driving information 421 being released, after the end time point 442 of the output section where the information 411 corresponding to the external vehicle is output. Moreover, the processor is configured to output information 412 generated by use of the driving information 421, the type information 423, the first data, and the second data.

Referring to a second example 402 in FIG. 4, in an exemplary embodiment of the present disclosure, the processor may identify an error 480 caused by driving information 471 associated with the driving of the external vehicle. For example, the processor may identify the error 480 caused by the driving information 471 occupying at least one core included in the processor. For example, the processor may identify that type information 473 is incapable of occupying at least one core, as the driving information 471 occupies the at least one core included in the processor.

For example, the processor may identify the error 480 based on identifying that the type information 473 is incapable of occupying the at least one core, as the driving information 471 occupies the at least one core included in the processor.

For example, the processor may identify a start time point 491 of an output section where information 461 corresponding to the external vehicle is output, and an end time point 492 of the output section where the information 461 corresponding to the external vehicle is output.

In an exemplary embodiment of the present disclosure, the processor may identify that the occupation of the driving information 471 is released, between the start time point 491 of the output section where information 461 corresponding to the external vehicle is output, and the end time point 492 of the output section where the information 461 corresponding to the external vehicle is output. The processor may identify that the type information 482 is incapable of occupying at least one core, based on identifying that the occupation of the driving information 471 is released, between the start time point 491 and the end time point 492.

The processor may temporarily stop outputting the information 461 corresponding to the external vehicle between the start time point 491 and the end time point 492, based on the occupation of the driving information 471 being released. For example, the processor may not output the information 461 corresponding to the external vehicle between the start time point 491 and the end time point 492, based on the occupation of the driving information 471 being released.

In an exemplary embodiment of the present disclosure, the processor may reduce the reliability of driving information associated with the driving of the external vehicle obtained after the end time point 492 to be lower than the reliability of driving information associated with the driving of the external vehicle obtained before the end time point 492 between the start time point 491 and the end time point 492 based on the occupation of the driving information 471 being released.

For example, the processor is configured to output information corresponding to the external vehicle by use of driving information associated with the driving of the external vehicle with reduced reliability, type information associated with the type of the external vehicle, the first data, and the second data.

As described above, the vehicle control apparatus according to an exemplary embodiment is configured to perform an operation in an emergency mode, preventing a system including the vehicle control apparatus from being initialized. The vehicle control apparatus may provide a function of stably performing driving assistance of the vehicle or autonomous driving of the vehicle by preventing the system from being initialized.

FIG. 5 shows an example of a vehicle control apparatus that switches a mode associated with driving from a normal mode to an emergency mode, in an exemplary embodiment of the present disclosure.

Referring to FIG. 5, a processor (e.g., the processor 110 in FIG. 1) of a vehicle control apparatus (e.g., the vehicle control apparatus 100 of FIG. 1) according to various exemplary embodiments of the present disclosure may receive, from a LiDAR (e.g., the LiDAR 120 in FIG. 1), type information 523 associated with the type of external vehicle and driving information 521 associated with driving of the external vehicle.

Referring to a first example 501 in FIG. 5, in an exemplary embodiment of the present disclosure, the processor may identify an error 530 that occurs based on the type information 523 occupying at least one core included in the processor.

For example, the processor may identify that the driving information 521 is incapable of occupying at least one core, as the type information 523 occupies the at least one core. The processor may identify the error 530 based on identifying that the driving information 521 is incapable occupying the at least one core, as the type information 523 occupies the at least one core.

In an exemplary embodiment of the present disclosure, the processor may identify a start time point 541 of an output section where information 511 corresponding to the external vehicle is output, and an end time point 542 of the output section where the information 511 corresponding to the external vehicle is output.

In an exemplary embodiment of the present disclosure, the processor may identify that the occupation of the type information 523 is released, after the end time point 542. The processor may identify that the driving information 521 is incapable of occupying at least one core, based on the fact that the occupation of the type information 523 is released, after the end time point 542.

In an exemplary embodiment of the present disclosure, the processor may remove first data associated with the driving of the external vehicle stored in a memory, second data associated with the type of the external vehicle stored in the memory, driving information associated with the driving of the external vehicle, and type information associated with the type of the external vehicle based on identifying that the driving information 521 is incapable of occupying at least one core, as the occupation of the type information 523 is released after the end time point 542.

In an exemplary embodiment of the present disclosure, the processor may remove the first data associated with the driving of the external vehicle stored in the memory, the second data associated with the type of the external vehicle stored in the memory, the driving information associated with the driving of the external vehicle temporarily stored in the processor or the memory, and the type information associated with the type of the external vehicle temporarily stored in the processor or the memory based on identifying that the driving information 521 is incapable of occupying at least one core, as the occupation of the type information 523 is released after the end time point 542.

Referring to a second example 502 in FIG. 5, in an exemplary embodiment of the present disclosure, the processor may receive type information 573 associated with the type of the external vehicle. The processor may identify a start time point 591 of an output section where information 561 corresponding to the external vehicle is output, and an end time point 592 of the output section where the information 561 corresponding to the external vehicle is output.

In an exemplary embodiment of the present disclosure, the processor may identify that the occupation of the type information 573 is released, between the start time point 591 and the end time point 592. The processor may identify an error 580 based on identifying that the occupation of the type information 573 is released, between the start time point 591 and the end time point 592.

The processor may identify that driving information 571 is incapable of occupying at least one core, based on identifying that the occupation of the type information 573 occupying at least one core is released, between the start time point 591 and the end time point 592.

In an exemplary embodiment of the present disclosure, the processor may temporarily stop outputting the information 561 corresponding to the external vehicle between the start time point 591 and the end time point 592, based on the fact that the occupation of the type information 573 occupying the at least one core is released. For example, the processor may not output the information 561 corresponding to the external vehicle between the start time point 591 and the end time point 592, based on the fact that the occupation of the type information 573 occupying the at least one core is released.

In an exemplary embodiment of the present disclosure, the processor may set the reliability of at least one of driving information associated with the driving of the external vehicle obtained after the end time point 592, or type information associated with the type of the external vehicle obtained after the end time point 592, or any combination thereof to be lower than the reliability of at least one of driving information associated with the driving of the external vehicle obtained before the start time point 591, or type information associated with the type of the external vehicle obtained before the start time point 591, or any combination thereof.

In an exemplary embodiment of the present disclosure, the processor may set the reliability of information 562 corresponding to the external vehicle output after the end time point 592 to be lower than the reliability of information corresponding to the external vehicle output before the start time point 591.

As described above, the vehicle control apparatus according to an exemplary embodiment is configured to perform an operation in an emergency mode, preventing a system including the vehicle control apparatus from being initialized. For example, the vehicle control apparatus may provide driving assistance to a vehicle or assist in autonomous driving of the vehicle by not initializing data stored in the memory.

FIG. 6 shows an example of a vehicle control apparatus that switches a mode associated with driving from a normal mode to an emergency mode, in an exemplary embodiment of the present disclosure.

Referring to FIG. 6, a processor (e.g., the processor 110 in FIG. 1) of a vehicle control apparatus (e.g., the vehicle control apparatus 100 of FIG. 1) according to various exemplary embodiments of the present disclosure may receive driving information 621 associated with the driving of an external vehicle from a LiDAR (e.g., the LiDAR 120 in FIG. 1).

In an exemplary embodiment of the present disclosure, the processor may receive the driving information 621 associated with the driving of the external vehicle. The processor is configured to generate and output information 610 corresponding to the external vehicle by use of the driving information 621 associated with the driving of the external vehicle, type information associated with the type of the external vehicle, first data associated with the driving of the external vehicle stored in a memory (e.g., the memory 130 in FIG. 1), and second data associated with the type of the external vehicle stored in the memory.

In an exemplary embodiment of the present disclosure, the processor may identify an error 630 associated with information 611 corresponding to the external vehicle. For example, the processor may identify a start time point 641 of an output section where the information 611 corresponding to the external vehicle is output, and an end time point 642 of the output section where the information 611 corresponding to the external vehicle is output.

In an exemplary embodiment of the present disclosure, the processor may identify that the information 611 corresponding to the external vehicle does not occupy at least one core, at the start time point 641 of the output section where the information 611 corresponding to the external vehicle is output.

In an exemplary embodiment of the present disclosure, the processor may identify that the occupation of the information 611 corresponding to the external vehicle has not started at the start time point 641.

For example, the processor may identify the error 630 based on the fact that the occupation of the information 611 corresponding to the external vehicle has not started at the start time point 641. The processor may not output the information 611 corresponding to the external vehicle based on identifying the error 630. For example, the processor may temporarily stop outputting the information 611 corresponding to the external vehicle based on identifying the error 630.

In an exemplary embodiment of the present disclosure, the processor may reduce the reliability of driving information 640 obtained after the error 630 occurs. For example, the processor may set the reliability of the driving information 640 obtained after the error 630 occurs, to be lower than the reliability of driving information obtained before the error 630 occurs.

In an exemplary embodiment of the present disclosure, the processor may set the reliability of the driving information 621 obtained for specified duration 650 to be lower than the reliability of the driving information 621 obtained for duration different from the specified duration 650.

The processor is configured to output information 613, which corresponds to the external vehicle and which is generated by use of the driving information 640 with the reduced reliability, driving information associated with the driving of the external vehicle stored in the memory, and type information associated with the type of the external vehicle stored in the memory.

As described above, the vehicle control apparatus according to an exemplary embodiment is configured to perform an operation in an emergency mode, preventing a system including the vehicle control apparatus from being initialized.

Hereinafter, a vehicle control method according to an exemplary embodiment of the present disclosure will be described in detail with reference to FIG. 7. FIG. 7 shows an example of a flowchart associated with a vehicle control method, according to an exemplary embodiment of the present disclosure.

Hereinafter, it is assumed that the vehicle control apparatus 100 of FIG. 1 is configured to perform the process of FIG. 7. Furthermore, in a description of FIG. 7, it may be understood that an operation described as being performed by a processor is controlled by the processor 110 of the vehicle control apparatus 100.

At least one of operations of FIG. 7 may be performed by the vehicle control apparatus 100 of FIG. 1. Each of the operations in FIG. 7 may be performed sequentially, but is not necessarily sequentially performed. For example, the order of operations may be changed, and at least two operations may be performed in parallel.

Referring to FIG. 7, in operation S701, a vehicle control method according to various exemplary embodiments of the present disclosure may include an operation of receiving, from a LiDAR, one of driving information associated with driving of an external vehicle, type information associated with a type of the external vehicle, or a first signal indicating an error occurring in the LiDAR.

In operation S703, the vehicle control method according to various exemplary embodiments of the present disclosure may include an operation of switching a mode associated with driving to an emergency mode different from a normal mode for outputting first information, which corresponds to the external vehicle and which is generated by use of first data associated with the driving of the external vehicle stored in a memory, second data associated with the type of the external vehicle stored in the memory, the driving information, and the type information, based on the driving information or the type information, which is incapable of occupying the at least one core, or receiving the first signal. For example, the vehicle control method may include an operation of switching the mode associated with the driving from the normal mode to the emergency mode.

The vehicle control method may include an operation of identifying the priority of each of a plurality of external objects based on at least one of a location of each of the plurality of external objects including the external vehicle, a size of each of virtual boxes respectively corresponding to the plurality of external objects, the number of points included in each of the virtual boxes, a type of each of the plurality of external objects, or a lane on which external vehicles included in the plurality of external objects are driving, or any combination thereof. For example, the vehicle control method may include an operation of identifying a priority in the normal mode and storing the identified priority in the memory.

For example, the type of each of the plurality of external objects may include at least one of a pedestrian type, a pole indicating a boundary of a lane including a traffic pole, or a vehicle type, or any combination thereof.

For example, the vehicle control method according to various exemplary embodiments of the present disclosure may include an operation of outputting information different from the driving information in the emergency mode, based on the identified priority.

The vehicle control method according to various exemplary embodiments of the present disclosure may include an operation of identifying a first lane, on which a vehicle is driving, and a second lane on which the external vehicle is driving. The vehicle control method according to various exemplary embodiments of the present disclosure may include an operation of identifying a priority of the external vehicle based on a distance between the first lane and the second lane. The vehicle control method according to various exemplary embodiments of the present disclosure may include an operation of outputting information different from the driving information in the emergency mode, based on the priority.

The vehicle control method according to various exemplary embodiments of the present disclosure may include an operation of not outputting the first information based on switching the mode associated with the driving to the emergency mode. For example, the vehicle control method according to various exemplary embodiments of the present disclosure may include an operation of temporarily stopping the output of the first information based on switching the mode associated with the driving to the emergency mode.

The vehicle control method according to various exemplary embodiments of the present disclosure may include an operation of reducing the reliability of the first information output at a first end time point after a first start time point of an output section, in which driving information is output, to be lower than the reliability of the driving information output before the first start time point.

The vehicle control method according to various exemplary embodiments of the present disclosure may include an operation of outputting the first information having the reduced reliability. For example, the operation of outputting information, which has the reduced reliability and which corresponds to the external vehicle, may include a recovery stage.

The vehicle control method according to various exemplary embodiments of the present disclosure may include an operation of receiving the first signal indicating an error occurring in the LiDAR. For example, the vehicle control method may include an operation of switching the mode associated with the driving from the normal mode to the emergency mode based on receiving the first signal indicating an error occurring in the LiDAR.

The vehicle control method may include an operation of generating second information corresponding to the external vehicle by use of the first data associated with the driving of the external vehicle stored in the memory, and the second data associated with the type of the external vehicle stored in the memory based on switching the mode associated with the driving to the emergency mode. The vehicle control method may include an operation of storing the generated second information in the memory.

The vehicle control method according to various exemplary embodiments of the present disclosure may include an operation of switching the mode associated with the driving from the normal mode to the emergency mode based on identifying that the type information is incapable of occupying at least one core as the driving information occupies the at least one core.

The vehicle control method according to various exemplary embodiments of the present disclosure may include an operation of outputting fourth information, which corresponds to the external vehicle and which is generated by use of the first data and the second data, based on the fact that the occupation of the driving information is released, after the second end time point of the output section for outputting the third information, which corresponds to the external vehicle and which is generated by use of the first data associated with the driving of the external vehicle stored in the memory, the second data associated with the type of the external vehicle stored in the memory, and the driving information associated with the driving of the external vehicle.

The vehicle control method according to various exemplary embodiments of the present disclosure may include an operation of switching the mode associated with the driving from the normal mode to the emergency mode based on identifying that the type information is incapable of occupying at least one core as the driving information occupies the at least one core.

The vehicle control method according to various exemplary embodiments of the present disclosure may include an operation of not outputting third information based on a fact that occupation of the driving information is released, between a second start time point and a second end time point of an output section for outputting the third information, which corresponds to the external vehicle and which is generated by use of the first data, the second data, and the driving information.

The vehicle control method according to various exemplary embodiments of the present disclosure may include an operation of switching the mode associated with the driving from the normal mode to the emergency mode based on identifying that the type information is incapable of occupying at least one core as the driving information occupies the at least one core.

The vehicle control method according to various exemplary embodiments of the present disclosure may include an operation of deleting the first data, the second data, the driving information, and the type information from the memory based on occupation of the type information is released, after a third end time point of an output section for outputting fifth information, which corresponds to the external vehicle and which is generated by use of the first data, the second data, and the type information.

The vehicle control method according to various exemplary embodiments of the present disclosure may include an operation of switching the mode associated with the driving from the normal mode to the emergency mode based on identifying that the type information is incapable of occupying at least one core as the driving information occupies the at least one core.

The vehicle control method according to various exemplary embodiments of the present disclosure may include an operation of not outputting fifth information based on a fact that occupation of the type information is released, between a third start time point and a third end time point of an output section for outputting the fifth information, which corresponds to the external vehicle and which is generated by use of the first data, the second data, and the type information.

The vehicle control method according to various exemplary embodiments of the present disclosure may include an operation of not outputting the first information based on a fact that an output of the first information starts, after a fourth start time point of an output section for outputting the first information.

The vehicle control method according to various exemplary embodiments of the present disclosure may include an operation of outputting sixth information, which corresponds to the external vehicle, which is generated by use of the first data, the second data, the driving information, and the type information, and which is obtained after the fourth start time point.

As described above, the vehicle control method according to various exemplary embodiments of the present disclosure may include operating in an emergency mode based on identifying an error. The vehicle control method may provide a function of stably assisting the driving of a vehicle including the vehicle control apparatus by not initializing the vehicle control apparatus and/or the vehicle control system including the vehicle control apparatus, even when an error occurring in LiDAR is identified.

Hereinafter, a vehicle control method according to an exemplary embodiment of the present disclosure will be described in detail with reference to FIG. 8. FIG. 8 shows an example of a flowchart associated with a vehicle control method, according to an exemplary embodiment of the present disclosure.

At least one of operations of FIG. 8 may be performed by the vehicle control apparatus 100 of FIG. 1. Each of the operations in FIG. 8 may be performed sequentially, but is not necessarily sequentially performed. For example, the order of operations may be changed, and at least two operations may be performed in parallel.

Referring to FIG. 8, in operation S801, a vehicle control method according to various exemplary embodiments of the present disclosure may include an operation of determining whether a signal indicating that at least one core included in a processor is incapable of being occupied has occurred.

In operation S803, the vehicle control method according to various exemplary embodiments of the present disclosure may include operating in a normal mode.

For example, the vehicle control method may include operating in the normal mode based on the fact that the signal indicating that at least one core is incapable of being occupied has not occurred.

In operation S805, the vehicle control method according to various exemplary embodiments of the present disclosure may include operating in an emergency mode.

For example, the vehicle control method may include operating in the emergency mode based on the fact that a signal indicating that at least one core is incapable of being occupied has occurred.

In operation S807, the vehicle control method according to various exemplary embodiments of the present disclosure may include an operation of determining whether a first condition is satisfied.

For example, the first condition may be associated with receiving a signal indicating an error occurring in a LiDAR. For example, the first condition may be associated with whether the signal indicating an error occurring in the LiDAR is received.

When the first condition is satisfied (Yes in operation S807), in operation S809, the vehicle control method according to various exemplary embodiments of the present disclosure may include operating in a first emergency mode. For example, the first emergency mode may include a mode in which output information is not output. For example, the output information may be generated based on first data associated with the driving of the external vehicle stored in a memory, second data associated with the type of the external vehicle stored in the memory, driving information associated with the driving of the external vehicle, and type information associated with the type of the external vehicle.

For example, the vehicle control method may include operating in the first emergency mode based on receiving a signal indicating an error occurring in the LiDAR.

When the first condition is not satisfied (No in operation S807), in operation S811, the vehicle control method according to various exemplary embodiments of the present disclosure may include an operation of determining whether a second condition is satisfied.

For example, the second condition may be associated with whether driving information associated with the driving of the external vehicle occupies at least one core.

When the second condition is satisfied (Yes in operation S811), in operation S813, the vehicle control method according to various exemplary embodiments of the present disclosure may include operating in a second emergency mode.

For example, the vehicle control method may include an operation of identifying an error occurring as the driving information associated with the driving of the external vehicle occupies at least one core. The vehicle control method may include operating in the second emergency mode based on an error occurring as the driving information associated with the driving of the external vehicle occupies at least one core. For example, the second emergency mode may include a mode in which the output information is not output.

When the second condition is not satisfied (No in operation S811), in operation S815, the vehicle control method according to various exemplary embodiments of the present disclosure may include an operation of determining whether a third condition is satisfied.

For example, the third condition may be associated with whether the type information associated with the type of the external vehicle occupies at least one core.

When the third condition is satisfied (Yes in operation S815), in operation S817, the vehicle control method according to various exemplary embodiments of the present disclosure may include operating in a third emergency mode.

For example, the vehicle control method may include an operation of identifying an error occurring as the type information associated with the type of the external vehicle occupies at least one core. The vehicle control method may include operating in the third emergency mode based on an error occurring as the type information associated with the type of the external vehicle occupies at least one core. For example, the third emergency mode may include a mode in which the output information is not output.

When the third condition is not satisfied (No in operation S815), in operation

S819, the vehicle control method according to various exemplary embodiments of the present disclosure may include operating in a fourth emergency mode. For example, the fourth emergency mode may include a mode in which the output information is not output.

According to an exemplary embodiment of the present disclosure, when the third condition is not satisfied, the vehicle control method may include an operation of determining whether the fourth condition is satisfied. For example, the fourth condition may be associated with whether the output information is output.

For example, the vehicle control method may include an operation of identifying that the fourth condition is satisfied, based on the output information not being output.

As described above, the vehicle control method according to various exemplary embodiments of the present disclosure may include operating in an emergency mode based on identifying an error. The vehicle control method may provide a function of stably assisting the driving of a vehicle including the vehicle control apparatus by not initializing the vehicle control apparatus and/or the vehicle control system including the vehicle control apparatus, even when an error occurring in LiDAR is identified.

FIG. 9 illustrates a computing system associated with a vehicle control apparatus or vehicle control method, according to an exemplary embodiment of the present disclosure.

Referring to FIG. 9, a computing system 1000 may include at least one processor 1100, a memory 1300, a user interface input device 1400, a user interface output device 1500, storage 1600, and a network interface 1700, which are connected to each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

The present technology may prevent initialization of the vehicle control apparatus or a vehicle control system including the vehicle control apparatus even when an error occurs due to a Light Detection and Ranging (LiDAR).

Moreover, the present technology may perform an operation different depending on information indicating that a core included in a processor is occupied.

Furthermore, the present technology may provide a function of stably assisting the driving of a vehicle including the vehicle control apparatus by not initializing the vehicle control apparatus or the vehicle control system including the vehicle control apparatus, even when an error occurring in LiDAR is identified.

Besides, a variety of effects directly or indirectly understood through the specification may be provided.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle control apparatus comprising:
a light detection and ranging (LiDAR);
a memory; and
a processor including at least one core and operatively connected to the LiDAR, wherein the processor is configured to:
receive, from the LiDAR, one of driving information associated with driving of an external vehicle, type information associated with a type of the external vehicle, or a first signal indicating an error occurring in the LiDAR; and
switch a mode associated with driving to an emergency mode different from a normal mode for outputting first information, which corresponds to the external vehicle and which is generated by use of first data associated with the driving of the external vehicle stored in the memory, second data associated with the type of the external vehicle stored in the memory, the driving information, and the type information, based on the driving information or the type information, which is incapable of occupying the at least one core, or receiving the first signal.

2. The vehicle control apparatus of claim 1, wherein the processor is further configured to:
not output the first information based on switching the mode associated with the driving to the emergency mode;
reduce reliability of the first information output at a first end time point after a first start time point of an output section, in which driving information is output, to be lower than reliability of the driving information output before the first start time point; and
output the first information having the reduced reliability.

3. The vehicle control apparatus of claim 1, wherein the processor is further configured to:
switch the mode associated with the driving from the normal mode to the emergency mode based on receiving the first signal;
generate second information corresponding to the external vehicle by use of the first data and the second data; and
store the second information in the memory.

4. The vehicle control apparatus of claim 1, wherein the processor is further configured to:
switch the mode associated with the driving from the normal mode to the emergency mode based on identifying that the type information is incapable of occupying the at least one core, as the driving information occupies the at least one core; and
output fourth information, which corresponds to the external vehicle and which is generated by use of the first data and the second data, based on a fact that occupation of the driving information is released, after a second end time point of an output section for outputting third information, which corresponds to the external vehicle and which is generated by use of the first data, the second data, and the driving information.

5. The vehicle control apparatus of claim 1, wherein the processor is further configured to:
switch the mode associated with the driving from the normal mode to the emergency mode based on identifying that the type information is incapable of occupying the at least one core, as the driving information occupies the at least one core; and
not output third information based on a fact that occupation of the driving information is released, between a second start time point and a second end time point of an output section for outputting the third information, which corresponds to the external vehicle and which is generated by use of the first data, the second data, and the driving information.

6. The vehicle control apparatus of claim 1, wherein the processor is further configured to:
switch the mode associated with the driving from the normal mode to the emergency mode based on identifying that the driving information is incapable of occupying the at least one core, as the type information occupies the at least one core; and
delete the first data, the second data, the driving information, and the type information from the memory based on occupation of the type information is released, after a third end time point of an output section for outputting fifth information, which corresponds to the external vehicle and which is generated by use of the first data, the second data, and the type information.

7. The vehicle control apparatus of claim 1, wherein the processor is further configured to:
switch the mode associated with the driving from the normal mode to the emergency mode based on identifying that the driving information is incapable of occupying the at least one core, as the type information occupies the at least one core; and
not output fifth information based on a fact that occupation of the type information is released, between a third start time point and a third end time point of an output section for outputting the fifth information, which corresponds to the external vehicle and which is generated by use of the first data, the second data, and the driving information.

8. The vehicle control apparatus of claim 1, wherein the processor is further configured to:
not output the first information based on a fact that an output of the first information starts, after a fourth start time point of an output section for outputting the first information; and
output sixth information, which corresponds to the external vehicle, which is generated by use of the first data, the second data, the driving information, and the type information, and which is obtained after the fourth start time point.

9. The vehicle control apparatus of claim 1, wherein the processor is further configured to:
identify a priority of each of external objects based on at least one of a location of each of the external objects including the external vehicle, a size of each of virtual boxes respectively corresponding to the plurality of external objects, a number of points included in each of the virtual boxes, a type of each of the external objects, or a lane on which external vehicles included in the external objects are driving, or any combination thereof; and
output information different from the driving information in the emergency mode, based on the priority.

10. The vehicle control apparatus of claim 1, wherein the processor is further configured to:
identify a first lane, on which a vehicle is driving, and a second lane on which the external vehicle is driving;
identify a priority of the external vehicle based on a distance between the first lane and the second lane; and
output information different from the driving information in the emergency mode, based on the priority.

11. A vehicle control method, the method comprising:
receiving, by a processor including at least one core, from a Light Detection and Ranging (LiDAR) operatively connected to the processor, one of driving information associated with driving of an external vehicle, type information associated with a type of the external vehicle, or a first signal indicating an error occurring in the LiDAR; and
switching, by the processor, a mode associated with driving to an emergency mode different from a normal mode for outputting first information, which corresponds to the external vehicle and which is generated by use of first data associated with the driving of the external vehicle stored in a memory, second data associated with the type of the external vehicle stored in the memory, the driving information, and the type information, based on the driving information or the type information, which is incapable of occupying the at least one core, or receiving the first signal.

12. The method of claim 11, further including:
not outputting, by the processor, the first information based on switching the mode associated with the driving to the emergency mode;
reducing, by the processor, reliability of the first information output at a first end time point after a first start time point of an output section, in which driving information is output, to be lower than reliability of the driving information output before the first start time point; and
outputting, by the processor, the first information having the reduced reliability.

13. The method of claim 11, further including:
switching, by the processor, the mode associated with the driving from the normal mode to the emergency mode based on receiving the first signal;
generating, by the processor, second information corresponding to the external vehicle by use of the first data and the second data; and
storing, by the processor, the second information in the memory.

14. The method of claim 11, further including:
switching, by the processor, the mode associated with the driving from the normal mode to the emergency mode based on identifying that the type information is incapable of occupying the at least one core, as the driving information occupies the at least one core; and
outputting, by the processor, fourth information, which corresponds to the external vehicle and which is generated by use of the first data and the second data, based on a fact that occupation of the driving information is released, after a second end time point of an output section for outputting third information, which corresponds to the external vehicle and which is generated by use of the first data, the second data, and the driving information.

15. The method of claim 11, further including:
switching, by the processor, the mode associated with the driving from the normal mode to the emergency mode based on identifying that the type information is incapable of occupying the at least one core, as the driving information occupies the at least one core; and
not outputting, by the processor, third information based on a fact that occupation of the driving information is released, between a second start time point and a second end time point of an output section for outputting the third information, which corresponds to the external vehicle and which is generated by use of the first data, the second data, and the driving information.

16. The method of claim 11, further including:
switching, by the processor, the mode associated with the driving from the normal mode to the emergency mode based on identifying that the driving information is incapable of occupying the at least one core, as the type information occupies the at least one core; and
deleting, by the processor, the first data, the second data, the driving information, and the type information from the memory based on occupation of the type information is released, after a third end time point of an output section for outputting fifth information, which corresponds to the external vehicle and which is generated by use of the first data, the second data, and the type information.

17. The method of claim 11, further including:
switching, by the processor, the mode associated with the driving from the normal mode to the emergency mode based on identifying that the driving information is incapable of occupying the at least one core, as the type information occupies the at least one core; and
not outputting, by the processor, fifth information based on a fact that occupation of the type information is released, between a third start time point and a third end time point of an output section for outputting the fifth information, which corresponds to the external vehicle and which is generated by use of the first data, the second data, and the driving information.

18. The method of claim 11, further including:
not outputting, by the processor, the first information based on a fact that an output of the first information starts, after a fourth start time point of an output section for outputting the first information; and
outputting, by the processor, sixth information, which corresponds to the external vehicle, which is generated by use of the first data, the second data, the driving information, and the type information, and which is obtained after the fourth start time point.

19. The method of claim 11, further including:
identifying, by the processor, a priority of each of external objects based on at least one of a location of each of the external objects including the external vehicle, a size of each of virtual boxes respectively corresponding to the external objects, a number of points included in each of the virtual boxes, a type of each of the external objects, or a lane on which external vehicles included in the external objects are driving, or any combination thereof; and
outputting, by the processor, information different from the driving information in the emergency mode, based on the priority.

20. The method of claim 11, further including:
identifying, by the processor, a first lane, on which a vehicle is driving, and a second lane on which the external vehicle is driving;
identifying, by the processor, a priority of the external vehicle based on a distance between the first lane and the second lane; and
outputting, by the processor, information different from the driving information in the emergency mode, based on the priority.
